(19) United States
(12) Patent Application Publication
(10) Pub. No.: US 2015/0348055 A1
(43) Pub. Date: Dec. 3, 2015

(54) ARCHITECTURE AND METHOD FOR CONTENT SHARING AND DISTRIBUTION

(71) Applicant: Samsung Electronics Co., LTD., Gyeonggi-DO (KR)

(72) Inventor: Gerard Dirk SMITS, Los Gatos, CA (US)

(21) Appl. No.: 14/724,644

(22) Filed: May 28, 2015

Related U.S. Application Data
(60) Provisional application No. 62/004,088, filed on May 28, 2014.
(60) Provisional application No. 62/039,295, filed on Aug. 19, 2014.

(51) Int. Cl. G06Q 30/00

(52) U.S. Cl. CPC G06Q 30/018

(57) ABSTRACT

Disclosed are an architecture and related systems, devices, and methods that can be used for content sharing and distribution. For example, a device such as a smartphone includes memory that stores items of content to which access is denied until a respective condition is satisfied. The items of content are downloaded and stored on the device at a point in time that is before the point in time at which the condition is satisfied. Once the condition for an item of content has been satisfied, access to the item of content is permitted, and the item of content can be presented (e.g., displayed or audibilized).

### RELATED U.S. APPLICATIONS

This application claims priority to the U.S. provisional application with Ser. No. 62/004,088, filed May 28, 2014, and also to the U.S. provisional application with Ser. No. 62/039,295, filed Aug. 19, 2014, both of which are hereby incorporated by reference in their entirety.

### BACKGROUND

There are, broadly speaking, at least a couple of paradigms for distributing content including multimedia content such as movies. In one conventional approach, an item of content is mailed in disk form to a subscriber who pays a periodic (e.g., monthly) fee for the opportunity to receive an “unlimited” number of items. In another conventional approach, an item of content is streamed over the Internet, for example, to a subscriber who has either paid a monthly fee for the service or has paid a one-time fee that allows the subscriber to access a particular item of content for a limited period of time or number of times.

A problem with the first approach is that, in actuality, the number of items is not unlimited and instead is constrained by the amount of time it takes to order, receive, and return an item before another item can be ordered. In other words, a subscriber can only have so many items at a time, and must return at least some items in order to get other items.

A problem with the second approach is that content streaming is becoming more and more popular, with video traffic exceeding 50 percent of the total traffic over content distribution networks (CDNs) according to some estimates. Thus, more and more bandwidth is being consumed to stream movies and other such items. The level of quality is influenced by bitrate and therefore, generally speaking, streaming is greedy in nature because each end-user will select the highest bitrate that can be handled by, for example, their Internet connection. As more and more bandwidth is consumed by content streaming, it is possible that content providers (and ultimately, subscribers) will be charged different rates according to, for example, the amount of bandwidth used, compromising if not ending the principle of net neutrality. As a result, the cost of streaming content could increase in the future. In any case, the quality of content streaming is affected by the amount of bandwidth available so that, absent some other type of solution, the capacity of CDNs will have to be constantly increased to keep up with the growing demand, resulting in increased costs and energy consumption.

A problem with both of the above approaches is loss of privacy. For example, it is easy for content providers and other entities (e.g., Internet service providers, telecommunication/satellite service providers, advertisers, and even governments) to monitor and/or learn the type of content requested by each subscriber. Many subscribers do not want others to know what type of content they are receiving, based simply on a belief that such information should remain private, but also to avoid unwanted intrusions into their daily lives such as targeted advertisements and spam email messages.

However, current paradigms make it difficult for subscribers to protect their privacy because subscribers must deal with content providers, Internet service providers, telecommunication or satellite service providers, and the like in order to receive content. These types of providers monopolize the virtual trail that connects subscribers to content, making it very easy for the providers to monitor and keep a record of what content is requested and received by each subscriber.

### SUMMARY

Embodiments according to the present invention pertain to, in general, an architecture and related systems, devices, and methods that can be used for content distribution and sharing in place of or in addition to conventional CDNs, and but do not rely on and therefore can bypass the virtual trail that connects content and service providers to content consumers.

In an embodiment, memory in a device is reserved for storing items of content. Such items of content include, but are not limited to, movies, music, games, electronic books, and software applications. In particular, in an embodiment, these items of content are preloaded by, for example, the device's manufacturer into the reserved memory but are locked in some manner (e.g., encrypted) to prevent them from being used until a user has been granted access to them, perhaps on a per-item basis. The reserved memory can be segmented (e.g., logically) into multiple memory containers, and content providers and other vendors can, for example, pay a fee to the device manufacturer that allows them to preload their content into one or more of the memory containers. A user of the device can be granted permission to access the locked content once a condition is satisfied, in return for payment of a fee or for some other consideration, for example. Mechanisms can be put in place to disguise or hide the user's identity and/or which items of content are unlocked, thereby maintaining the user's privacy and preventing other entities such as service providers, governments, and advertisers from determining which items of content the user has an interest in.

Significantly, one or more of the items of content can be subsequently transferred from one device (a first device) to one or more other devices via a short-range wireless connection, in which the first device is brought relatively close to (e.g., within about an inch of, or touching, or within the normal distance of two people standing next to each other) a second device. A wired connection that connects devices directly can also be used. Accordingly, eavesdropping on the transfer is prevented and thus privacy is maintained. Furthermore, the transfer can be accomplished in a manner that does not reveal the identity of any of the users of any of the devices and/or disguises or hides which items of content have been transferred. The content transferred to another device can be locked; a user of the other device can subsequently unlock the content as mentioned above. In turn, the content can be transferred from the second device(s) to other devices, and so on.

Consequently, content can be rapidly spread in a secure and private manner to many different users over a spontaneous or ad hoc virtual private network, so to speak, that only exists while two or more devices are proximate to one another and, by virtue of the proximity, cannot be monitored. Memory capacities of devices such as smartphones are already large and continue to increase, so users can store a virtually limitless number of items (“limitless” in the sense that users can store more hours of content than might be available for viewing). Also, the distribution of content in this manner does not consume the bandwidth of a CDN. With more widespread distribution over a less expensive, virtualized, and decentralized architecture, costs and energy consumption can be reduced. For example, costs to consumers can be reduced because the consumers do not necessarily have to subscribe and pay a service fee to wireless network service providers or Internet service providers (ISPs). Net neutrality is preserved, as ISPs and the like are not involved in the exchange of content and thus do not have veto power over how much content can be exchanged.

These and other objects and advantages of the various embodiments of the present disclosure will be recognized by those of ordinary skill in the art after reading the following detailed description of the embodiments that are illustrated in the various drawing figures.

This summary is provided to introduce a selection of concepts in a simplified form that is further described below in the detailed description that follows. This summary is not intended to identify key features or essential features of the present disclosure, nor is it intended to be used to limit the scope of the present disclosure.

### BRIEF DESCRIPTION OF DRAWINGS

The accompanying drawings, which are incorporated in and form a part of this specification and in which like numerals depict like elements, illustrate embodiments of the present invention and, together with the detailed description, serve to explain the principles of the disclosure.

FIG. 1 is a block diagram illustrating an example of an architecture for sharing and distribution content in an embodiment according to the present invention.

FIG. 2 is a block diagram illustrating memory in a device such as a smartphone in an embodiment according to the present invention.

FIG. 3 is a flowchart of an example of a method for unlocking content in an embodiment according to the present invention.

FIG. 4 is a block diagram illustrating an example of an architecture for sharing and distribution content in an embodiment according to the present invention.

FIG. 5 is a block diagram illustrating information associated with an item of content in an embodiment according to the present invention.

FIGS. 6A and 6B are block diagrams illustrating examples of content distribution in embodiments according to the present invention.

FIG. 7 is a block diagram of an example of a device such as a smartphone on which embodiments according to the present invention can be implemented.

FIG. 8 is a flowchart of examples of computer-implemented operations for acquiring, distributing, and accessing content in embodiments according to the present invention.

### DETAILED DESCRIPTION

Reference will now be made in detail to the various embodiments of the present invention, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present invention, numerous specific details are set forth in order to provide a thorough understanding of the present disclosure. However, it will be understood that the present invention may be practiced without these specific details. In other instances, well-known methods, procedures, components, and circuits have not been described in detail so as not to unnecessarily obscure aspects of the present invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “encrypting,” “locking,” “unlocking,” “verifying,” “authorizing”, “determining,” “loading,” “establishing,” “presenting,” “downloading,” “uploading,” “making,” or the like, refer to actions and processes of a computer system or similar electronic computing device (e.g., a smartphone or tablet) or processor. A computer system or similar electronic computing device manipulates and transforms data represented as physical (electronic) quantities within the computer system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read-only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

Embodiments according to the present invention can be implemented on or using a device, particularly a mobile device, such as but not limited to: a smartphone; an electronic book (e-book) reader; a laptop, tablet, or handheld computer; a gaming device (e.g., a video game console); or the like. An example of a device is shown in FIG. 3, described further below.

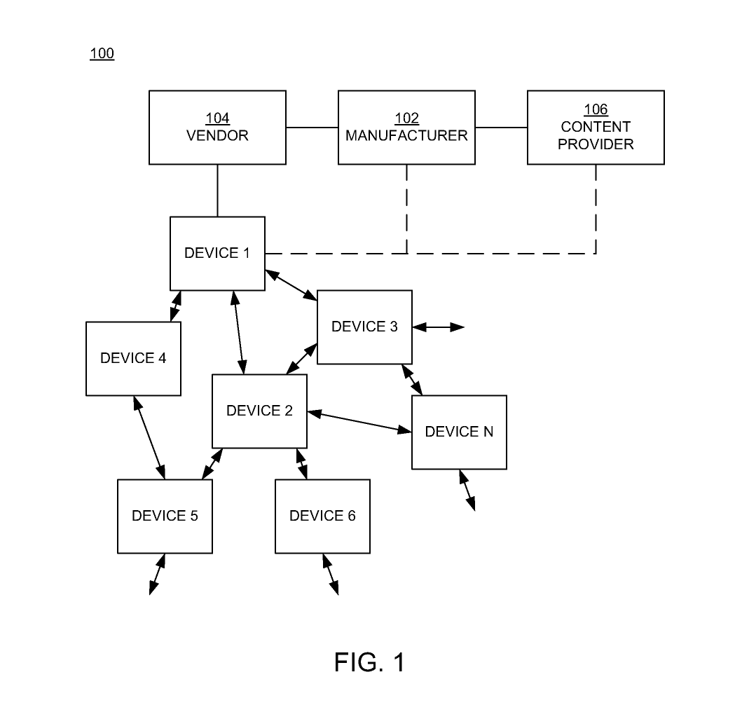

With reference first to FIG. 1, a block diagram illustrating an example of a network architecture or framework 100 for content sharing and distribution in an embodiment according to the present disclosure is shown. The network 100 includes a number of elements that can be present in the network at some times but not present at other times. In other words, as will be seen from the discussion below, membership in the network 100 is fluid, depending on what functions are being performed and what services are being provided in a particular timeframe. Accordingly, the network 100 can be referred to as a spontaneous virtual private network (SVPN).

In the example of FIG. 1, the network 100 includes a device manufacturer 102, a device vendor 104, and a content source and/or provider 106. There may be more than one device manufacturer, more than one device vendor, and more than one content source/provider. Also, the functions and services performed by the individual elements may be combined and performed by a single entity. That is, for example, a device manufacturer may also be a device vendor.

The device manufacturer 102 can manufacture and distribute (e.g., sell) end-user devices 1, 2, 3, . . . , N (1-N), such as but not limited to the types of devices mentioned above, to the device vendor 104. The devices 1-N can be the same type of device (e.g., each is a particular model of smartphone) or different types of devices (e.g., one device is one type of smartphone, another device is another type of smartphone, another device is a laptop, and so on).

The content source and/or provider 106 may be a producer of content, which it then distributes on its own or through another party (e.g., a distributor), or it may be that other party (e.g., it may be a distributor that acquires content from a content source). In general, the content source/provider 106 can provide items of content that are preloaded onto the devices 1-N. For example, the items of content can be preloaded as part of the manufacturing process, or at some point after the devices leave the manufacturer but before they are leased or purchased. The content source/provider 106 can also provide items of content that can be downloaded to the devices 1-N at any time. Items of content include, but are not limited to, movies, music, other types of audio and/or image-based content including voice messages and pictures, games, e-books, software applications, and email messages.

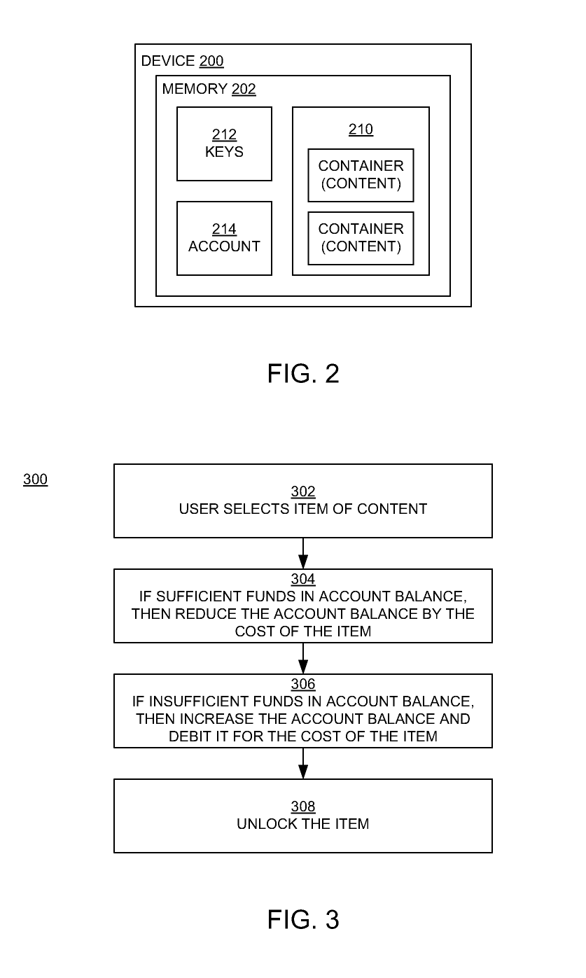

The device manufacturer 102 and/or the device vendor 104 can sell or lease memory space on the devices to the content provider 106; conversely, one or more content providers can acquire (purchase or lease) memory space on one or more of the devices 1-N. For example, memory on the devices can be segmented into one or more memory containers (FIG. 2), and each container can be sold or auctioned (individually or in a group) to a content provider. Different content providers can compete (based on price, for example) for each of the different memory containers on each of the various devices. In essence, the memory containers are analogous to cargo space, and the items of content are analogous to cargo.

The amount of memory space on devices such as (though not limited to) smartphones continues to increase with improvements in memory technologies (e.g., flash memory) and decreases in cost. Consequently, there may be relatively sizeable amounts of memory that are not otherwise being used (e.g., for applications) and are available for use as containers to store and carry (transport) content. Embodiments according to the present invention provide a practical and advantageous use for that memory space.

Importantly, content can be stored and transported by devices (e.g., smartphones) securely, in many different senses of the word “securely.” For example, the content can be secure in the sense that it is encrypted using strong cryptographic methods. The content is also secure in the sense that it is protected against viruses and is guarded so that it cannot infect its host device with a virus. The content is also secure in the sense that it is safe against inspection by unauthorized entities. That is, although the content may be inspected by anti-virus software and may be accessible to another device (e.g., a smartphone) that is seeking to download content, it can also be securely stored so that information about what is stored on a device, information about the device's user, and information about the user's interests are not revealed in an unauthorized manner or without the knowledge (and permission) of the user.

The device vendor 104 can sell or lease the devices 1-N to users. The purchase of devices by users can be done in a manner that is anonymous; the device vendor 104 does not necessarily have to know who is purchasing its devices. For example, the devices, with preloaded content, can be acquired using vending machines (e.g., kiosks) in public places using a prepaid debit card or in exchange for cash or bitcoins, for example. Also, the content provider 106, the device manufacturer 102, or the device vendor 104 may establish their own currency for use with this type of service. The devices, with preloaded content, can also be acquired using other, non-anonymous means such as conventional credit or debit cards. The price of a device can be established based on the type of device and its capabilities and capacities (e.g., memory size) and also based on the type and number of preloaded items of content (e.g., a movie may be priced higher than a song, one movie may be priced higher than another movie, and 100 movies may be priced higher than 20 movies).

The security of the devices and the privacy of their users can be enhanced through the use of biometrics, for example. That is, once a device is purchased from a vending machine or kiosk, it is not necessary for a user to enter personal information into the device. Instead, the user can, for example, imprint the device with his/her biometric data. This not only prevents unauthorized access to the device, but also maintains the anonymity of the user. The device does not need to know who the user is (e.g., it does not need to store the name of the user); the device only needs to be able to recognize that the user is the person that matches the imprinted biometric data. Accordingly, the device can monitor the user's likes and dislikes (preferences), which can be used to help select new items of content for the device, but the user's identity remains private. For example, a device can be preloaded with the first three episodes of a particular series; if the user views all three episodes, then remaining episodes can be downloaded to the device at the next opportunity. A user can also establish settings that are stored by device and that identify the user's like and dislikes.

Furthermore, big data techniques can be used to stochastically determine a user's preferences and to select appropriate content to be downloaded. Each device (e.g., smartphone) contains a large amount of information that can be used to determine the preferences of its users. These preferences can be determined while maintaining the anonymity of the user; as just described, the device only knows that the user is the person authorized to use it (e.g., based on the person's biometrics) but does not need to know, for example, the person's name.

On the other hand, a user may choose to identify who they are and/or provide their preferences directly to a content provider.

User preferences can be private, semi-private, or not private at all, depending on how the user wants to handle such information. In an embodiment, side data can be transmitted from device-to-device or from device-to-content provider. The side data can identify a user's preferences, e.g., what the user has watched, wants to watch, liked, or disliked. The side data could be sent anonymously, just as the items of content are distributed anonymously as previously described herein. In other words, the side data can be considered as another form of the content that is handled privately as described herein. Alternatively, the side data can be handled with varying degrees of privacy, depending on the amount of information a user is willing to divulge.

The person who purchases a device may have immediate access to the preloaded items of content by virtue of paying the purchase price of the device. Alternatively, the preloaded items of content may be locked (e.g., encrypted) in some manner, preventing the user from accessing the items until some other condition is met. For example, the user might have to pay, or authorize payment to, the content provider 106, the device manufacturer 102, or the device vendor 104 in order to access the preloaded content either item-by-item or in entirety. The price of a device that includes preloaded but locked content may be lower than a comparable device having preloaded content that is not locked. The purchase price may be fixed, or it may be adjusted in real time based on, for example, scarcity or demand. For example, live content associated with a widely-viewed national or global event (e.g., a sporting event such as a world-wide soccer tournament) might be priced higher than recorded content of the same event made available after the event is over. As another example, the price for an item of content in a part of the world where it is difficult to access that content may be higher than in a part of the world where it is otherwise difficult to find that content; e.g., an internationally popular American television show might be priced higher in India than it is in America. On the other hand, content might be priced lower if a vendor is trying to increase market share in a market that is otherwise not accessible; e.g., a content provider in India seeking access to the American market might lower the price of an item of content (e.g., a movie) to increase distribution in and revenues from America.

A payment to unlock content can be made in a manner that disguises or hides the user's identity but is still traceable to the device. Once proper payment is made, a signal can then be sent to the device that either unlocks the content itself or contains a key that can be used to unlock the content, for example. The key may be based on, for example, a cryptography scheme that utilizes both a public key and a private key. Generally speaking, payment can be made without the recipient of the payment knowing who made the payment and which item(s) of content is/are being unlocked and/or accessed (e.g., viewed). Keys can be revoked or disabled remotely to prevent access to content. Keys may have an expiration date, or may be limited in the number of times they may be used.

As mentioned above, the user can continue to remain anonymous while paying for access, depending on how payment is made. For example, with reference to the example of FIG. 2, a device 200 can include memory 202 that is preloaded with locked items of content 210, keys 212, and an account balance 214. There may be a key for each item of content. The account balance 214 includes a preloaded amount of funds; the amount may be set by the purchase price of the device or it may be specified by the user at the time of purchase and included in the purchase price, for example. The account balance 214 can be increased by transferring funds electronically, for example. In an implementation, direct memory access (DMA) can be used to transfer funds, to increase the level of security and privacy.

In this example, with reference also to FIG. 3, the following steps can be performed to unlock an item of content: i) the user selects the item (block 302); ii) if there are sufficient funds, then the account balance 214 is reduced by the cost of the selected item (block 304); iii) if there are not sufficient funds, then the account balance 214 can be increased by the user and then debited for this transaction (block 306); and iv) once payment is made, one of the keys 212 is used to unlock the item (block 308), which can now be accessed by the user.

There are other ways that content on a device can be unlocked. For example, any of the above steps can be performed by interacting, through the device, with any one or more of the content provider 106, the device manufacturer 102, or the device vendor 104, as needed. This can be accomplished anonymously because, as mentioned above, the device does not need to know the identity of the user and so cannot reveal it.

Also, there may be ways to pay for this service other than on a per-item basis. For example, a user can pay a monthly fee that allows the user to access a prescribed (perhaps unlimited) number of items of content.

In an embodiment, after an item is unlocked and accessed/used, the item is returned to the state it was in prior to being unlocked (e.g., it can be relocked) so that, should the device be accessed by an unauthorized user, it may not be possible to determine what items have been unlocked.

New items of content, in addition to the preloaded items, can be downloaded to a device at any time. A user can select which new items of content are to be downloaded, or new items of content can be selected and downloaded automatically based on user preferences and habits derived from information on the device as described previously herein. The new items of content can be purchased and downloaded in an anonymous manner, such as through the aforementioned vending machines/kiosks, which can in turn be periodically updated with new content by the content provider 106. For example, the content 210 can be refreshed/reset by wirelessly communicating with the vending machine/kiosk over a very short range (e.g., within a couple of feet of, within inches of, or in direct contact with the vending machine/kiosk) and perhaps using DMA. New items of content can also be downloaded while the device is being charged, as described further below.

The keys 212 and account balance 214 can be refreshed/reset in a similar manner. Alternatively, the new items of content can be purchased and downloaded by interacting with any of the content provider 106, the device manufacturer 102, or the device vendor 104, as needed, over a conventional CDN, for example. As another alternative, the locked content 210, keys 212, and/or account balance 214 can be refreshed/reset using a stand-alone, non-volatile memory device (e.g., a subscriber identity module [SIM] card) that contains a variety of locked items of content and also may contain the keys needed to unlock the items of content.

With reference again to FIG. 1, items of content can be distributed peer-to-peer, that is, from an upstream device (e.g., the device 1) to one or more other downstream devices (e.g., the devices 2, 3, and 4) via a short-range wireless (e.g., radio frequency) connection (e.g., near-field communication). For example, to transfer an item of content from the device 1 to the device 2, the devices 1 and 2 can be brought very close together (e.g., within about an inch of each other) or in physical contact with one another. Generally speaking, to transfer content from one device to another, the devices are close enough to be within range of each other. To preserve privacy, the range can be short enough to prevent another device from eavesdropping on the transfer and determining what is being transferred. Such wireless connections can be accomplished very quickly and using little power. DMA can be used to increase the level of security and privacy. Currently, it is possible to exchange about one gigabyte of data in about three seconds (e.g., about ten movies per minute) using less than one Joule (the battery capacity of conventional devices is about 30,000 Joules). Thus, the impact on battery power of transferring content is not significant. To increase the transfer rate, memories can be implemented and written to in parallel. A wired connection can also be used.

Furthermore, the transfer can be accomplished in a manner that does not reveal the identity of the user of either device, does not reveal details about either device, and/or disguises or hides which item of content has been transferred from an upstream device to a downstream device and vice versa.

The content provided to the downstream device may be locked. If locked, a key for unlocking the content may also be transferred to the downstream device along with the item of content. The item of content can be unlocked by, for example, debiting the account balance residing on the downstream device or by making proper payment as previously described herein.

In turn, the content (e.g., in locked form) can be distributed from the devices 2, 3, and 4 to other devices (e.g., the devices 5 and 6), which can distribute the content (e.g., in locked form) to yet other devices, and so on. If the content is locked, it can be handled as described above. Consequently, content can be distributed in an anonymous manner without consuming bandwidth in a CDN.

Moreover, content can be rapidly distributed. For example, if each user were to distribute an item of content to five other users, then the item would reach about two million people in nine “hops” and ten million people in ten hops. Thus, the download of one item has the potential to reach millions of viewers.

Communication between devices can be established in an ad hoc (spontaneous) manner. It is not necessary for users to know each other; for example, two strangers waiting at an airport can exchange items of content in an anonymous manner. As mentioned previously herein, a device can track its user's likes and dislikes without knowing the identity of the user, or a user can establish settings that identify his/her preferences. Thus, for example, if the device 2 user has or appears to have a preference for comedies, that information can be presented by the device 2 to the device 1 once communication between the devices is established (e.g., by touching the devices) and without revealing the device 2 user's identity. A similar transfer can occur in the opposite direction, from the device 2 to the device 1. In an embodiment, the device 1 can make it known to the device 2 what items of content related to the device 2 user's preferences are stored by the device 1, so that the device 2 can then determine whether the device 1 is storing items of content not already stored on the device 2. Alternatively, the device 2 can make it known what items of content it is storing (in addition to providing its user's preferences to the device 1 as mentioned above), and the device 1 can then transfer any items of content that satisfy the device 2 user's preferences and are not already stored on the device 2. As noted previously herein, the transferred items of content may be locked, and keys for locked content may also be transferred from the device 1 to the device 2.

An exchange may not be reciprocal. That is, for example, one device can send content to another device, but may not receive content from that other device.

Generally speaking, content can be rapidly exchanged between devices using any form of near-field communication, for example, with each user's permission. A user does not necessarily have to give permission for each exchange. That is, a user can store (e.g., in their user-specific settings) general permission to permit all exchanges, or limited permission to conduct certain types of exchanges, or no permission to conduct any exchange without explicit user approval. As mentioned above, the impact on battery power is not significant, but if a user is concerned about power consumption, then the user can establish a setting that limits the number of exchanges that can occur over a specified period of time, for example, or the device can have a setting that permits exchanges only if battery capacity is above a certain level.

In an implementation, the device manufacturer 102, device vendor 104, and/or content provider 106 may identify a group of core users that serve as the initial point-of-contact for distributing content. For example, a core user may be given a device at reduced or no cost, with increased memory capacity, if they will undertake the responsibility of acting as a gateway to other users and devices. A core user would be responsible for frequently downloading new content on a regular basis and then distributing that content to other users and their devices. Thus, the SVPN 100 (FIG. 1) is continually recharged with fresh content.

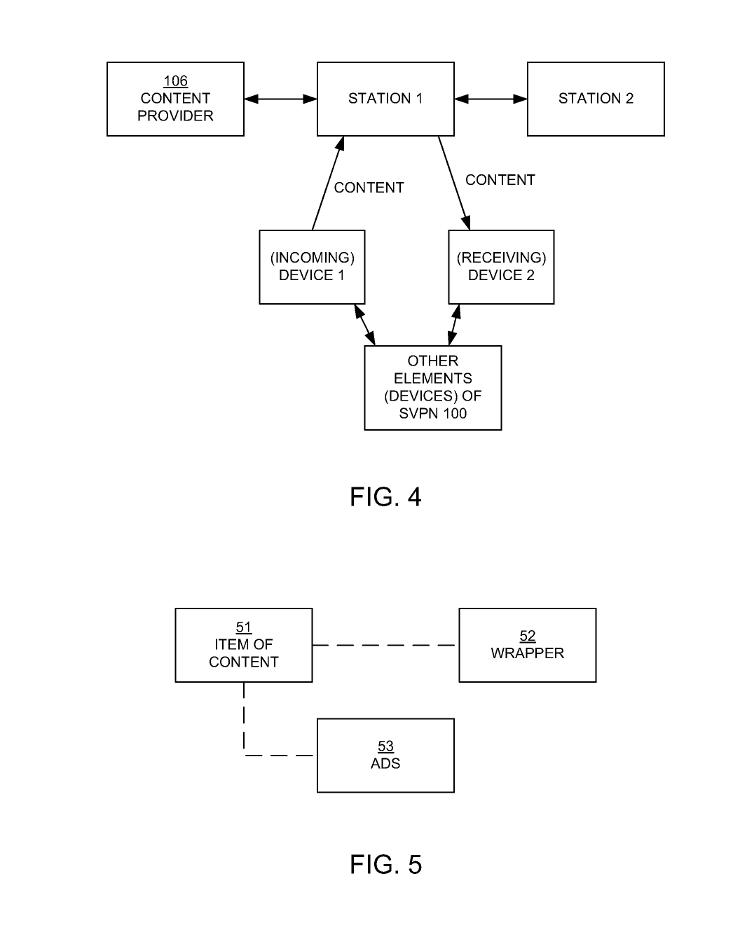

Instead of or in addition to the use of core users as described above, a group of stand-alone share points (e.g., stations 1 and 2 of FIG. 4) that have large amounts of storage space could be used as the mechanism for exchanging content and recharging the SVPN 100 with fresh content. The stations 1 and 2 can be located in public places, particularly places that see a lot of traffic (e.g., coffee shops, shopping centers, and airports). Such stations can facilitate the transfer of content because transfers can be asynchronous. That is, it is not necessary for two devices (e.g., smartphones) to be in proximity to one another; instead, the device 1 can download information to the station 1, and the other device 2 can download information from the station 1 at any time afterwards.

To encourage their use, the stations can be power-charging stations with extra storage that can copy items of content or containers from devices of users who use the stations to charge their devices and/or get new items of content or containers. For example, stations can be wired for power and/or they could generate their own power (e.g., from natural or artificial light).

An incoming device 1 could transfer (deposit) an item or items of content to the station 1, and/or pick up one or more items of content from that station. The exchange of content may or may not be free of charge. The stations can receive or make payment in an anonymous manner, as previously described herein. For example, a station can maintain a balance of virtual cash that can be used to make payment if the station is purchasing content and accept payment if the station is selling content. In an implementation, multiple devices could use a station at the same time. Content deposited by the device 1 can be downloaded by the device 2. The stations facilitate anonymous exchanges of content; it is not necessary for a station to know who is using the device.

In an embodiment, the device (e.g., a smartphone) can be configured so that the portions of memory (e.g., containers) that hold content to be shared are open only when the device is connected to the station or charger and/or is uploading or downloading content to or from the station.

The stations can communicate with each other over a wired or wireless network (e.g., the Internet); e.g., a station can be a node on or an extension of an existing network. However, stations can instead communicate with each other outside of such a network, by placing messages onto the user devices. When a device is connected to a station, it can transfer any messages it has previously received from other stations to the station it is now connected to, and can also receive messages from that station that in turn can be passed to any other station that the device may be subsequently connected to.

Each station can maintain a table that keeps track of what items of content it currently is storing, what items of content are in or not in demand (what specific items of content are in or not in demand, or what type of content is in or not in demand), what types or items of content are being shared consistently and what items or types of content are not, and other information associated with tracking (anonymously) users' content choices. Containers can be addressed or identified with large (e.g., 100 bits or more) random numbers that uniquely describe their contents, perhaps with a hash. Each item of content 51 (FIG. 5) can be identified by its own unique identifier (ID). The identifier can be large enough to be unique, but small enough so that it can be transferred quickly. For example, an identifier for an item of content can be a unique combination of 6000 bytes. Based on such information, a station can issue a request for specific content, either to other stations or to a content source, either directly over a network or indirectly in the ad hoc, peer-to-peer manner described just above. Similarly, stations can learn from information carried on the devices themselves or information attached to the content. For example, in an embodiment, a “wrapper” 52 is associated with each item of content. The wrapper 52 can be used to identify, for example, the origin of the item of content on the device (from what station the item of content was downloaded), the number of hops between the originating station and the current station (e.g., the number of other stations that the device was connected to between the originating and current stations), the items unique identifier, and other information that helps track users' content choices, how the content is being distributed, and the like. A station can use the information it learns from the various devices it has been in contact with to determine what items of content are in or not in demand (what specific items of content are in or not in demand, or what type of content is in or not in demand), what types or items of content are being shared consistently and what items or types of content are not, and other information that can help the station determine which items of content it should stock.

A station in a relatively remote or isolated location that does not have a lot of visitors or that has only local visitors, for example, can receive new content outside of the SVPN 100 using more conventional means. For example, new content can be shipped to such a station on a physical disk or streamed to the station over the Internet from, for example, the content provider 106. Most locations regularly receive mail or shipments of some sort, and new content can also or alternatively be delivered and picked up as part of those normal visits.

The stations could opportunistically pass along items of content or containers for the purpose of, for example, better geographical distribution; e.g., if, at a European station, a traveler likely headed to the U.S. is identified, then content that is prevalent in Europe could be downloaded onto that user's device to help introduce that content to the U.S. That content can be subsequently shared with another user or with a station in the U.S., and can be propagated from user/station to user/station as previously described herein. Thus, for example, stations located in airports can be the backbone of an ad hoc global distribution network that allows content to be distributed over great distances and into new markets.

To encourage sharing of content, users can be rewarded with, for example, free content or free power charging. Reward programs could be modeled on, for example, frequent flier programs, where rewards are made after some measure of sharing passes a threshold and the types of rewards may increase in value as the measure of sharing increases in value.

As previously described herein, some users may be designated as core users. In addition to receiving a high-capacity device at reduced cost, a core user can be rewarded in other ways. For example, rewards can be earned depending on some measure of feedback about the value of the service a core user provides, or based on how often the core user transfers content, or based on the number of referrals attributable to the core user—in short, each core user can be graded on how he/she represents, advertises, and propagates the type of content sharing service described herein, and rewarded accordingly.

As described above, a single download has the potential to reach millions of viewers. Thus, the architecture and services described herein can be used to the benefit of content producers that do not have large budgets at their disposal. For example, a content producer can shoot a video and provide it free-of-charge to some number of users. Those users in turn can distribute the video in locked form to a second tier of users in the manner disclosed herein, except that the second-tier users have to pay a fee (perhaps a small fee) to unlock the video; at least a portion of the fee is forwarded to the content producer. The second-tier users can transfer the video (in locked form) to another group of users, who have to pay a fee (a portion of which goes to the content producer), and so on. The fee for unlocking the video can be increased each time it is transferred to another user. In this manner, a content producer can distribute video inexpensively (outside of conventional CDNs) and recover costs, and perhaps make a profit. As products such as virtual reality goggles (e.g., Oculus Rift) and compact, high-definition camcorders (e.g., GoPro™) become more popular, the ability to rapidly and inexpensively distribute videos as described herein may be particularly valuable.

In essence, smartphones and other devices can be to content providers what parcel delivery services are to online shopping Web sites, with the additional benefit of maintaining user privacy. Because the disclosed architecture/services are outside of conventional CDNs, content can be transferred without the mechanisms required by CDNs, such as deep packet inspections and specific personal destinations.

The architecture and services described herein can be used in other ways as well. For example, when a user travels from America to India, content can be downloaded in India to the user's device (e.g., smartphone) and transported back to America when the user returns there. Available memory space can be utilized; if there is not enough memory, then existing items of content can be temporarily deleted and restored when the user returns to America. In this manner, content can be distributed to areas that might be otherwise inaccessible or difficult to access. Furthermore, content can be distributed from user A to user C via user B (the traveler); user A can thus transfer content to user C without being in the proximity of user C. Also, large amounts of content can perhaps be transferred more quickly in this manner relative to streaming the content. For example, depending on the amount of data, it can be quicker to physically transfer the data by airplane using a number of devices (e.g., smartphones) than to stream the data over the Internet.

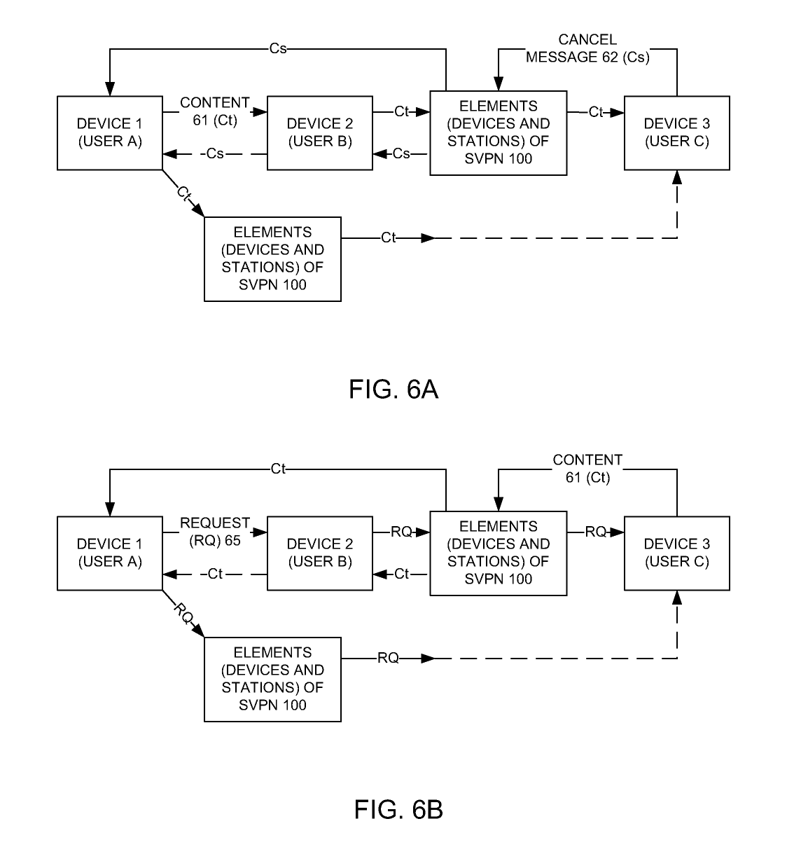

Also, the architecture and services described herein can be employed to transport a specific item of content from one user/device to a specific user/device through intermediate devices even if the intermediate users (the owners of the intermediate devices) have no interest in the content or do not plan to access the content. For example, suppose that a user A wants to transfer a particular item of content 61 to a particular user C (FIG. 6A). The user A can associate information that identifies the user C with the particular item of content 61, or the device 3 that belongs to the user C, as the intended destination. Information identifying the user C or the device 3 as the intended destination can be included in the wrapper 52 (FIG. 5) associated with the item of content 61, for example. The item of content 61 can be transferred from the device 1 of the user A to the device 3 of the user C via the device 2 of a user B (and perhaps the devices of many other intermediate users and also perhaps through stations) even if each intermediate user and station has no interest in accessing or storing the item; each intermediate user/device/station simply serves to facilitate the transfer from the user A to the user C, at no charge to the intermediate users/devices/stations, and without the intermediate users knowing what was being transferred. In a sense, the item of content 61 is broadcast by the device 1 of the user A to other devices/stations, which in turn broadcast the item of content to other devices/stations, and so until the item of content reaches the device 3 of the user C; however, the broadcast is done asynchronously, and is accomplished by a series of asynchronous broadcasts to one device or station at a time (with multiple such broadcasts occurring in parallel) rather than by single broadcasts to large numbers of devices/stations.

In an embodiment, once the item of content 61 reaches its intended destination (e.g., the user C, or the device 3 that belongs to the user C), a cancel signal or message 62 can be issued by the destination device (the device 3 belonging to the user C) and propagated back and throughout the SVPN 100 in the same manner as content is propagated forward though the SVPN. That is, the cancel message 62 is uploaded by the destination device 3 to one or more other devices/stations, which in turn transfer the message to yet other devices/stations, and so on, and in this manner the cancel message is distributed across the SVPN 100. The cancel message indicates that the content has been received by its intended recipient (the device 3) and that it no longer needs to be transferred from device to device (or device to station, or station to device), and in fact can be deleted from any device/station on which it is being stored. The return paths taken by the cancel message 62 are not necessarily the reverse order of the paths taken by the item of content 61.

In a similar manner, a particular user can issue a request 65 (FIG. 6B) for a particular item of content. In a sense, the request is analogous to an item of content like a video. That is, a device (e.g., the device 3) can upload a request 65 to one or more devices or stations (or device to station, or station to device), and they in turn propagate the request from device/station to device/station across the SVPN 100 just like an item of content is propagated from device/station to device/station. The request is propagated until it reaches a device (e.g., the device 1) that has the particular item of content 61 of interest. That device can then send the item of content 61 back to the requesting device in a manner like that described in the example of FIG. 6A, in which the user A sends a particular item of content to the user C. The return paths taken by the item of content 61 are not necessarily the reverse order of the paths taken by the request 65. Once the requested item of content 61 reaches the requesting device 1, a cancel message 62 can be issued by the requesting device as described above.

Significantly, content can be delivered from user/device to another user/device securely. For example, the intended recipient may be known only to an item of content being delivered and is not revealed by the device. That is, the correct destination is known to the item of content but is not made known to each intermediate device/station that is forwarding that content. Instead, the item of content itself recognizes that it has reached the intended destination when it is transferred to the correct device. Information can be associated with or included in the item of content that identifies the intended destination device; for example, a wrapper (previously described herein) associated with the item of content can include information that identifies or describes the intended destination. Such information can be based on information that was included in a request for that item of content as described above. Alternatively, such information can be input by a user of the sending device as described in the example above. If the particular item of content is transferred to a device that is not the correct device, then it continues to be transferred until it reaches the correct device (the intended destination), which can then send a cancel message as described above. In this manner, content can be forwarded to a destination (e.g., a device) without revealing the destination and without the destination being known to any of the intermediate devices/stations or their users.

It is recognized that the ad hoc approach described herein may make it more difficult to deliver content between two users according to a specific schedule; however, mechanisms can be established to facilitate delivery by a deadline. For example, a package-embedded clock, an expiration time stamp, and a delivery deadline can be used in a scheme that invokes a wireless upload at a given point in time. Statistical predictions can be used to manage delivery. Delivery can be made by a combination of wired/wireless communications over a high-bandwidth network and the device-to-device transfers disclosed herein. Hot spots could be distributed to offload bottlenecks. Transmissions could be delayed until a high bandwidth device is detected nearby. Also, as the number of devices that participate in the ad hoc SVPN 100 continues to grow, then the content being delivered would be expected to be propagated more quickly.

As another example, the architecture and services described herein can be employed to transfer content between devices in situations that might otherwise overwhelm a server or Web site. For example, at a large event like a concert, members of the audience might all try to download content from the band's Web site at the same time. Instead, because the users' devices are in wireless contact with each other, a relatively small number of devices can access the Web site first and download the content, then automatically (and anonymously) distribute that content to nearby devices, which automatically (and anonymously) propagate the content to yet more devices, and so on until all interested parties have received the content. Whether or not a party is interested in the content can be derived from preferences that either the user has entered into his/her device or are derived or inferred from information on the device (e.g., as described above, the device can anonymously monitor a user's likes and dislikes). Using the mechanisms described above, such a peer-to-peer network would be private and secure.

In an embodiment, advertisements (ads) 53 (FIG. 5) are also preloaded on a user device (e.g., a smartphone) along with the other items of content. The ads are then presented based on, for example, the item of content 51 currently being accessed by the user or information about the user (the information about the user may be entered by the user, or derived as described above). Ads can be presented at a point where they will have the most potential impact (e.g., a car ad can be placed after the same make of car is shown in a movie). New ads can be added to the device in the same manner as other items of content are added, as described above. Similarly, ads can be distributed between devices just as other items of content are distributed. The number of times that an ad is viewed can be counted. However, the ads viewed by a particular user can be kept private.

The amount of data that can be transferred from device to device as described herein is substantial and perhaps would overwhelm a conventional CDN. Content delivery providers that use conventional CDNs might have to charge more to deliver this scale of data. However, because the disclosed architecture and services do not rely on the infrastructure required by CDNs and instead are implemented outside that infrastructure, costs can be controlled even without net neutrality. The production and distribution of content can grow unfettered by the constraints associated with CDNs, such as lack of available bandwidth and the need for additional infrastructure. In essence, the size and capacity of the SVPN 100 (FIG. 1) grows as a natural consequence of the increase in users and devices. This advantage will likely grow in importance as more and more people produce and want to share/distribute their content (e.g., videos) as mentioned above.

Nevertheless, the architecture and services described herein do not necessarily replace conventional CDNs, but can be used to ease the demand on CDNs. Also, the architecture and services described herein can be integrated with CDNs. For example, as mentioned above, a CDN can be used to deliver content to the core users, and/or can be used as a bridge that spans between two remote devices. In the latter case, for example, an item or items of content can be transferred between devices over the SVPN 100 as described above, then transferred via a conventional CDN to another device, which in turn transfers the content to other devices via an SVPN.

On the other hand, for some users, the architecture and services described herein obviate the need for Internet service providers, telecommunication or satellite service providers, and the like. These types of service providers will not be needed to receive content, thus overcoming the “last mile” monopoly held by service providers and thereby also precluding them from monitoring and keeping records of what content is requested and received by each subscriber.

The architecture and services described herein can be used as an alternative to conventional streaming paradigms such as music streaming. For example, very large numbers of audio files (e.g., songs) can be preloaded on a device such as a smartphone but locked as described above. Then, instead of accessing a digital media store to purchase a song, a user can essentially shop for the song on his or her smartphone, and then can unlock the song as described previously herein rather than stream or download the song from the digital media store.

To summarize, embodiments according to the present invention allow content to be readily shared and distributed. An item of content can be transferred in a matter of seconds and using a relatively small amount of energy simply by touching or nearly touching two devices. Other advantages include: independence from carriers; privacy; and savings in infrastructure bandwidth, energy, and costs. By its very nature, an SVPN as described herein can provide privacy by virtue of its potentially massive size and by the magnitude of the content being exchanged. In effect, each user is lost in a crowd. Also, users may download content that they have no interest in addition to the content in which they are interested, but it will difficult and perhaps impossible to distinguish between the two, and so each user's actual preferences can be guarded.

Generally speaking, users keep devices like smartphones nearby. A device loaded with content as described herein can be carried to virtually any location and communicatively attached to (e.g., plugged into) an audio/video device such as a television. Thus, content can be readily transported to and consumed anywhere, including remote locations that do not have satellite, cable, or Internet access.

Also, generally speaking, memory capacity is increasing faster than bandwidth. Preloading content on devices such as smartphones saves at least some bandwidth; bandwidth is only needed for updates and to add new content. The amount of preloaded content can be large (e.g., one terabyte), so the bandwidth needed for content distribution can be reduced by that amount, per user or per device. Furthermore, that amount of content does not need to be stored on multiple servers around the world. In effect, each device (e.g., smartphone) is akin to a content server and, in the aggregate, the devices constitute a CDN.

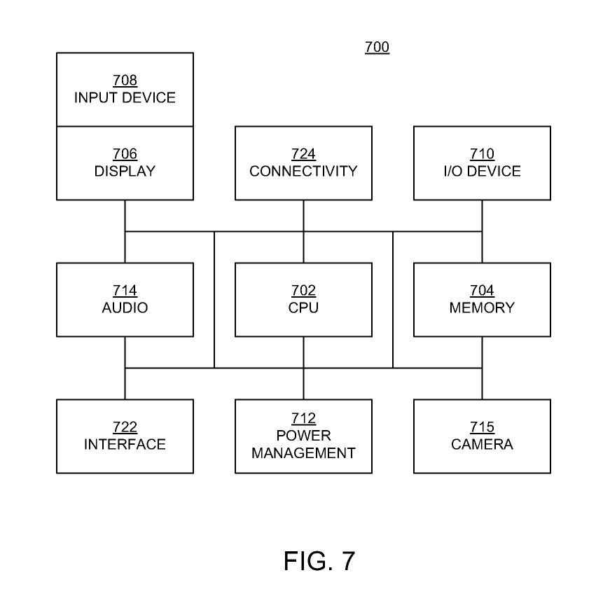

FIG. 7 is a block diagram of an example of a computing system 700 capable of implementing embodiments according to the present disclosure. The computing system 700 broadly represents any single or multi-processor computing device or system capable of executing computer-readable instructions. Depending on the implementation, the computing system 700 may not include all of the elements shown in FIG. 7, and/or it may include elements in addition to those shown in FIG. 7. The computing system 700 may be a device such as those described above, including: a smartphone; an e-book reader; a laptop, tablet, or handheld computer; a gaming device; or the like. The computing system 700 is an example of the devices 1-N of FIG. 1. Note the computing system 700 may have the functionality of a smartphone or the like, for example, but not outwardly appear to be such a device. In other words, the devices 1-N may be made to look like some other type of device, e.g., an innocuous-looking device. Such a device can be small by making it solid-state, and can also be inexpensive.

In its most basic configuration, the computing system 700 may include at least one processor 702 (CPU) and at least one memory 704. The CPU 702 generally represents any type or form of processing unit capable of processing data or interpreting and executing instructions. In certain embodiments, the CPU 702 may receive instructions from a software application or module. These instructions may cause the processor 702 to perform the functions of one or more of the example embodiments described and/or illustrated herein. The CPU 702 may include a communications processor and an applications processor. The applications processor may be used to decode (decompress) and render movies, for example.

The memory 704 generally represents any type or form of volatile or non-volatile storage device or medium capable of storing data and/or other computer-readable instructions. In certain embodiments the computing system 700 may include both a volatile memory unit (such as, for example, the memory 704) and a non-volatile storage device (not shown).

The computing system 700 may also include a display device 706. The display device 706 is generally configured to display a graphical user interface (GUI) that provides an easy to use interface between a user and the computing system.

The computing system 700 may also include an input device 708. The input device 708 may include a touch sensing device (a touch screen) configured to receive input from a user's touch and to send this information to the CPU 702, which can interpret the touches in accordance with its programming.

An input device 708 may be integrated with the display device 706 or they may be separate components. In the illustrated embodiment, the input device 708 is a touch screen that is positioned over or in front of the display device 706.

The communication interface 722 of FIG. 7 broadly represents any type or form of communication device or adapter capable of facilitating communication and data transfer (wired or wireless) between the example computing system 700 and one or more additional devices including network devices and audio/video devices such as televisions.

The computing system 700 may also include a connectivity subsystem 724, including a transceiver (or a transmitter and a receiver) and an antenna.

As illustrated in FIG. 7, the computing system 700 may also include at least one input/output (I/O) device 710. Examples of an I/O device 710 include, without limitation, a keyboard, a pointing or cursor control device (e.g., a mouse), a speech recognition device, or any other input device.

The computing system 700 may include a power management subsystem 712, including a battery, a battery charger, and adaptor connections.

The computing system 700 can include an interface 730, such as a Universal Serial Bus (USB) connector, that can be used for both data transfer and battery charging, in lieu of or in addition to parts of the power management subsystem 712 and the communication interface 722.

The computing system 700 may also include an audio subsystem 714, including a speaker and a microphone. The computing system 700 may also include a camera subsystem 715.

Many other devices or subsystems may be connected to computing system 700. Conversely, all of the components and devices illustrated in FIG. 7 need not be present to practice the embodiments described herein. The devices and subsystems referenced above may also be interconnected in different ways from that shown in FIG. 7. The computing system 700 may also employ any number of software, firmware, and/or hardware configurations.

A computer-readable medium containing the computer program may be loaded into the computing system 700. All or a portion of the computer program stored on the computer-readable medium may then be stored in the memory 704. When executed by the CPU 702, a computer program loaded into the computing system 700 may cause the CPU 702 to perform and/or be a means for performing the functions of the example embodiments described and/or illustrated herein. Additionally or alternatively, the example embodiments described and/or illustrated herein may be implemented in firmware and/or hardware.

A portion (e.g., a terabyte) of the memory 704—the portion may be referred to herein as a hold—can be reserved for content from content providers. The hold may be logically divided into different containers. A large (e.g., 100-bit) random number can be associated with each container and can be used as an address or unique identifier for the container.

As mentioned above, the containers can be preloaded with content from content providers that buy or lease the containers. A user can purchase the device (e.g., a smartphone or other type of device) with the preloaded content. As described above, the device can be purchased anonymously but can be associated with a specific user through biometrics, for example.

The content in a container may or may not be encrypted. The content in one or more containers, or the entire hold itself, can be copied or forwarded to another device that has a similar container or hold, as previously described herein.

Content can also be downloaded or updated through the interface 730 while the device is charging, for example. The new content can be provided for a fee or for free.

The content to be added or updated can be selected according to user preferences derived from which items of content the user has accessed and viewed or listened to. Also, as described above, big data techniques can be used to stochastically determine the user's preferences and to select appropriate content to be downloaded.

As mentioned previously herein, in an embodiment, a wrapper 52 (FIG. 5) is associated with each item of content 51. The wrapper 52 is used to identify whether the associated item of content 51 has been accessed by a user. The wrapper could include other information, such as the number of times the item is accessed, the duration of each access, the frequency of accesses, and/or the geographic location of the device when the item was accessed. The wrapper stays within a device's memory (e.g., within the container that holds the associated item of content) to maintain privacy. The wrappers can be used to indicate what items of content a user is interested in and hence to identify what other items of content might be of interest to the user, without identifying the user. A wrapper may be opened (read) by the device when a particular item of content is purchased or unlocked, for example. When an item of content is deleted from the device, the wrapper can be left behind in memory to serve the purposes just described, and to prevent the associated item of content from being downloaded again.

In an embodiment, a key is needed to unlock a wrapper. The keys could be revoked or disabled to prevent access to the wrapper and hence to the associated content.

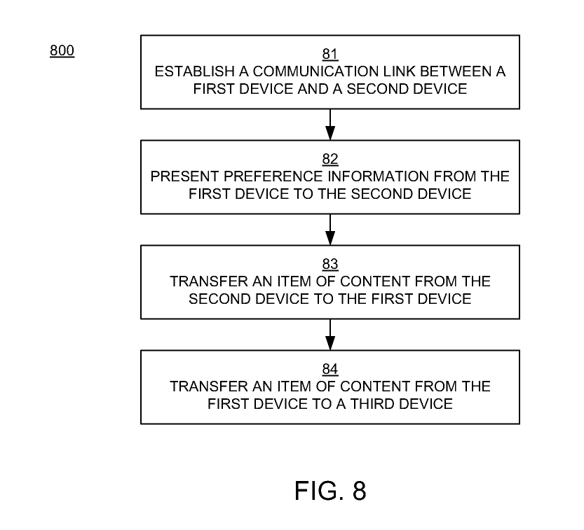

FIG. 8 is a flowchart 800 of examples of computer-implemented operations for acquiring, distributing, and accessing content in embodiments according to the present invention. The flowchart 800 can be implemented as computer-executable instructions residing on some form of non-transitory computer-readable storage medium and executed in an apparatus or computer system using a processing device or circuit such as the devices described above in conjunction with FIGS. 1-5, 6A, and 6B and exemplified by the computing system 700 of FIG. 7.

In block 81 of FIG. 8, a communication link is established between a first device and a second device.

In block 82, the first device presents preference information to the second device. The preference information indicates a type of content of interest to a user of the first device. The identity of the user of the first device is kept secret from the second device. Also, the identity of the user of the second device is kept secret from the first device.

In an embodiment, the first device determining stochastically the preference information based on other information stored by the first device while maintaining the anonymity of the user.

In block 83, an item of content is transferred from the second device to first device. The item of content satisfies the preference information. Access by the first device to the item of content is denied until a condition associated with the item of content is satisfied. Once the condition is satisfied, access to the item of content is permitted.

In an embodiment, a payment that satisfies the condition is made. The payment is made without revealing information about the user of the first device.

In an embodiment, a wrapper is associated with the item of content. The wrapper can include information such as, but not limited to, information that uniquely identifies the item of content, information indicating whether the item of content has been accessed, information identifying the number of times the item of content has been accessed, information identifying a geographic location when the item of content was accessed, and information that identifies the first device as the destination for the item of content.

In block 84, in an embodiment, the first device establishes a communication link with a third device, and uploads an item of content to the third device. The first device can receive preference information from the third device indicating the type of content of interest to a user of the third device, and the item of content uploaded to the third device satisfies the preference information from the third device. The identity of the user of the first device is kept secret from the third device, and the identity of the user of the third device is kept secret from the first device.

In an embodiment, the first device is a smartphone, and the second device and the third device are a smartphone, a kiosk, a vending machine, or a battery charging station.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in that order. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

Although the subject matter has been described in language specific to structural features and/or methodological acts, it is to be understood that the subject matter defined in the disclosure is not necessarily limited to the specific features or acts described above. Rather, those specific features and acts are disclosed as example forms of implementing the disclosed invention.

What is claimed is:

1. A device, comprising:
memory that stores a plurality of items of content to which access is denied until a respective condition is satisfied, wherein the items of content are downloaded and stored on the device at a point in time that is before the point in time at which the condition is satisfied;
a processor coupled to the memory that verifies whether a condition for an item of content stored in the memory has been satisfied, wherein once the condition for the item of content has been satisfied, the processor permits access to the item of content; and
an output device coupled to the processor that presents the item of content once the condition has been satisfied.

2. The device of claim 1, wherein the items of content that are downloaded and stored are selected based on user preferences that are provided to a provider of the items of content.

3. The device of claim 1, wherein the items of content that are downloaded and stored are selected based on an analysis of information stored on the device.

4. The device of claim 1, further comprising:
a battery; and
an interface coupled to the memory and to the battery, the interface operable both for battery charging and for data transfer, wherein items of content are downloadable to the device via the interface while the device is being charged using the interface.

5. The device of claim 1, wherein the memory is logically divided into a plurality of containers, wherein one or more of the containers are allocated to a content provider that provides items of content that are preloaded into the one or more containers.

6. The device of claim 5, wherein each container of the plurality of containers is addressed using a respective random number.

7. The device of claim 1, further comprising a transmitter coupled to the memory, wherein an item of content stored in the memory is transmitted to another device via near-field communication.

8. The device of claim 1, further comprising a receiver coupled to the memory, wherein an item of content is received from another device via near-field communication.

9. The device of claim 1, wherein a wrapper is associated with the item of content, the wrapper comprising information selected from the group consisting of: information that uniquely identifies the item of content; information indicating whether the item of content has been accessed; information identifying the number of times the item of content has been accessed; and information identifying a geographic location of the device when the item of content was accessed.

10. The device of claim 9, wherein the wrapper is private to the device so that the wrapper is accessible only by the device and is not accessible to another device.

11. The device of claim 9, wherein the wrapper is stored by the device and remains stored by the device if the item of content is deleted from the memory.

12. The device of claim 1, further comprising a communication interface coupled to the memory, wherein the communication interface is operable for communicatively connecting the device to a second device and for transferring the item of content to the second device for presentation.

13. The device of claim 1, wherein the memory comprises information useful for identifying an authorized user of the device while maintaining the anonymity of the authorized user.

14. The device of claim 1, wherein the memory includes information comprising an account balance, wherein the condition comprises satisfactorily debiting the account.

15. The device of claim 1, wherein the item of content is selected from the group consisting of: a movie, music, audio-based content, image-based content, a game, an electronic book, an e-mail message, and a software application; and wherein the output device is selected from the group consisting of: a display, and a speaker.

16. The device of claim 1, wherein the items of content comprise advertisements, wherein an advertisement is selected and presented based on which other item of content is being accessed and presented.

17. A method of acquiring and accessing an item of content on a first device comprising memory, a processor, and an output device, the method comprising:
establishing a communication link with a second device;
presenting preference information to the second device, the preference information indicating a type of content of interest to a user of the first device, wherein the identity of the user of the first device is kept secret from the second device; and
downloading an item of content from the second device that satisfies the preference information, wherein access by the first device to the item of content is denied until a condition associated with the item of content is satisfied, wherein once the condition is satisfied, access to the item of content is permitted.

18. The method of claim 17, further comprising the first device determining stochastically the preference information based on other information stored by the first device while maintaining the anonymity of the user.

19. The method of claim 17, further comprising making a payment that satisfies the condition, the payment made without revealing information about the user.

20. The method of claim 17, wherein the identity of a user of the second device is kept secret from the first device.

21. The method of claim 17, further comprising:
establishing a communication link with a third device; and
uploading an item of content to the third device.

22. The method of claim 21, wherein the first device comprises a smartphone, and wherein each of the second device and the third device comprises a device selected from the group consisting of: a smartphone, a kiosk, a vending machine, and a battery charging station.

23. The method of claim 21, further comprising receiving preference information from the third device, the preference information from the third device indicating a type of content of interest to a user of the third device, wherein the identity of the user of the first device is kept secret from the third device and vice versa, wherein the item of content uploaded to the third device satisfies the preference information from the third device.

24. The method of claim 17, further comprising:
uploading a request for a particular item of content to another device; and
uploading a cancel message to another device in response to downloading the particular item of content.

25. The method of claim 17, wherein a wrapper is associated with the item of content, the wrapper comprising information selected from the group consisting of: information that uniquely identifies the item of content; information indicating whether the item of content has been accessed; information identifying the number of times the item of content has been accessed; information identifying a geographic location when the item of content was accessed; and information that identifies the first device as the destination for the item of content.

26. A method of distributing content from a first device comprising memory, a processor, and an output device, the method comprising:
establishing a communication link with a second device; and
uploading an item of content to the second device, wherein access by the second device to the item of content is denied unless a condition associated with the item of content is satisfied.

27. The method of claim 26, further comprising receiving preference information from the second device, the preference information indicating a type of content of interest to a user of the second device, wherein the identity of the user of the second device is kept secret from the first device and the identity of the user of the first device is kept secret from the second device, and wherein the item of content satisfies the preference information.

28. The method of claim 26, wherein the second device comprises a smartphone, and wherein the first device comprises a device selected from the group consisting of: a smartphone, a kiosk, a vending machine, and a battery charging station.

29. The method of claim 26, further comprising receiving a request for a particular item of content, wherein the item of content satisfies the request and is uploaded in response to the request.

30. The method of claim 26, further comprising receiving a cancel message that identifies the item of content.

31. The method of claim 26, wherein a wrapper is associated with the item of content, the wrapper comprising information selected from the group consisting of: information that uniquely identifies the item of content; information indicating whether the item of content has been accessed; information identifying the number of times the item of content has been accessed; information identifying a geographic location when the item of content was accessed; and information that identifies the second device as the destination for the item of content.
